(19) United States
(12) Patent Application Publication
(10) Pub. No.: US 2007/0252499 A1
(43) Pub. Date: Nov. 1, 2007

(54) Scanning microscope

(75) Inventors: Holger Birk, Meckesheim (DE); Rafael Storz, Heidelberg (DE); Dirk-Oliver Fehrer, Oftersheim (DE); Claus Kress, Neckargmund (DE)

Correspondence Address: HOUSTON ELISEEVA, 4 MILITIA DRIVE, SUITE 4, LEXINGTON, MA, 02421, US

(73) Assignee: Leica Microsystems CMS GmbH, Wetzlar (DE)

(21) Appl. No.: 11/252,965

(22) Filed: Oct. 18, 2005

(30) Foreign Application Priority Data
Oct. 18, 2004 (DE) DE 10 2004 050 86
Dec. 3, 2004 (DE) DE 10 2004 058 56

(51) Int. Cl. G02B 21/28

(52) U.S. Cl. 313/12

(57) ABSTRACT

A scanning microscope, in particular a confocal scanning microscope, having: a scanning device (1), a detection device (2), an electronic system (3) for operating the scanning microscope, and a cooling device (4) for at least one component of the scanning microscope, is configured and refined, in the interest of efficient cooling, in such a way that the cooling device (4) is operable with a liquid cooling medium.

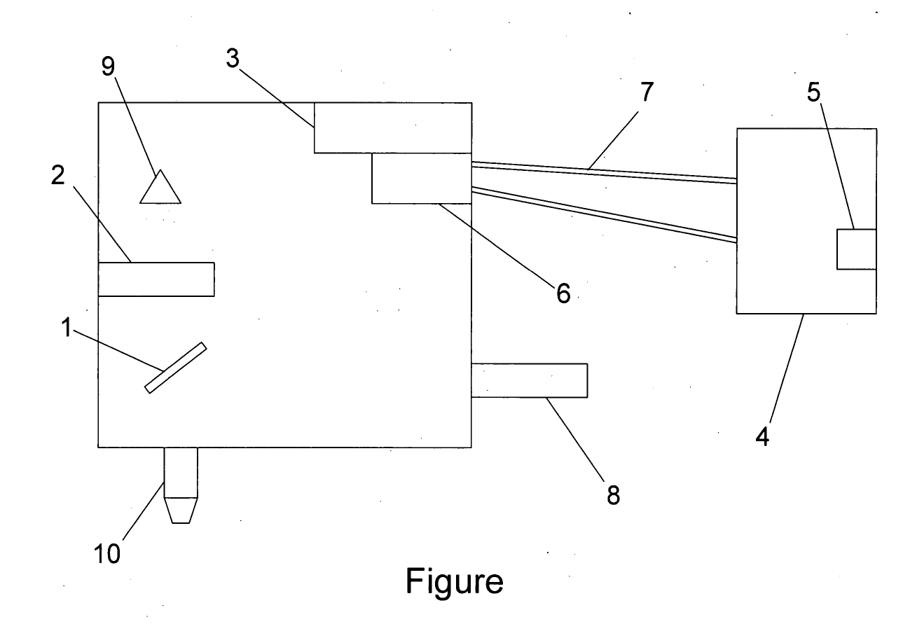

### RELATED APPLICATIONS

This application claims priority to German patent application number DE 10 2004 050 866.6, filed Oct. 18, 2004, which is incorporated herein by reference in its entirety.

### FIELD OF INVENTION

The present invention concerns a scanning microscope, in particular a confocal scanning microscope, having: a scanning device, a detection device, an electronic system for operating the scanning microscope, and a cooling device for at least one component of the scanning microscope.

### BACKGROUND OF THE INVENTION

Scanning microscopes of the kind cited above are known from practical use. The known scanning microscopes comprise, in particular, a scanning device, a detection device, and an electronic system for operating the scanning microscope. Because components heat up during operation, known scanning microscopes often comprise a cooling device for at least one component of the scanning microscope. Known cooling devices usually operate with air as the cooling medium. In individual cases, Peltier elements are also additionally used to cool detectors of the detection device.

It has been found in practical use that with the known cooling devices, the cooling power often is not sufficient. Power levels greater than 10 W can occur, in particular, in the region of galvanometers of the scanning device and in particular with rapid line deflection. With insufficient cooling, damage can occur to individual components of the scanning microscope as a result of overheating. If photomultipliers are furthermore used as detectors of the detection device, waste heat is then produced by the high-voltage power supply and voltage dividers of the dynodes. The achievable signal-to-noise ratio is greatly degraded by an increase in the detector temperature.

### SUMMARY OF THE INVENTION

It is therefore the object of the present invention to describe a scanning microscope of the kind cited initially in which efficient cooling is achieved with means of simple design.

The aforesaid object is achieved by a scanning microscope having the features of claim 1. According to the latter, the scanning microscope of the kind cited initially is embodied and refined in such a way that the cooling device is operable with a liquid cooling medium.

What was recognized according to the present invention was firstly that a cooling device that works with air has little power because of the low heat capacity of air. It was then additionally recognized according to the present invention that a cooling device working with a liquid cooling medium makes possible a substantially higher cooling power. A definite increase in performance in the known scanning microscopes is achievable as a result of the improved cooling device. The signal-to-noise ratio, in particular, is greatly improved with corresponding cooling of the detection device.

The scanning microscope according to the present invention consequently makes available a scanning microscope in which efficient cooling is achieved with means of simple design.

The cooling device could serve to cool different components of the scanning microscope. In particularly useful fashion the cooling device could be embodied, concretely, to cool the scanning device. Because intense heating, which ultimately can lead to overheating damage, can occur in particular in the region of galvanometers of the scanning device that serve to deflect scanning mirrors, the cooling device could be embodied to cool at least one galvanometer, in particular in the region of the line deflection system of the scanning device.

Alternatively or in addition thereto, the cooling device could be embodied to cool the detection device. Particularly favorable in this context is cooling of one or more photomultipliers that can be used as detectors of the detection device. Such photomultipliers usually comprise high-voltage power supplies and voltage dividers of the dynodes, which heat up intensely. The ultimate result is to make possible an improvement in the signal-to-noise ratio in the region of the detection device.

Also alternatively or additionally, the cooling device could be embodied to cool the electronic system; a particularly good choice here is cooling of an A/D converter and/or a microcontroller, which usually generate waste heat during operation. Here as well, it is possible on the one hand to protect the components from damaging overheating and on the other hand to prevent the occurrence of heat-related noise.

For cooling of the components, the components could comprise one or more conduits for the cooling medium to flow through. In this case the cooling medium absorbs heat from the components directly via the cooling medium flowing through. That heat is then dissipated in suitable fashion by means of the cooling medium. In other words, for this purpose the components to be cooled are to be embodied in suitable fashion with one or more conduits.

Concretely, the scanning device and/or the at least one galvanometer and/or the line deflection system and/or the detection device and/or the photomultiplier and/or the electronic system and/or the A/D converter and/or the microcontroller and/or a housing or base of the aforesaid components and/or a housing or base of another component of the scanning microscope could comprise one or more conduits for the cooling medium to flow through.

In order to make available a particularly capable and versatile cooling device, the cooling device could be combined with a Peltier cooling system. The cooling device could be embodied, in that context, in such a way that operation either of the cooling device with the liquid cooling medium or of the Peltier cooling system, or simultaneous operation of both cooling systems, is implementable. A user could, in this context, select the suitable cooling mode depending on the application.

In the interest of reliable dissipation of waste heat from the scanning microscope, the cooling device could comprise a preferably external cooling-medium/air heat exchanger. In order to implement a particularly compact scanning microscope, however, the cooling device could also comprise a heat exchanger arranged in the scanning microscope or in a scanning head. This is to be determined by the particular application and the cooling power required.

To ensure a reliable flow of the cooling medium to the regions of the scanning microscope that are to be cooled, the cooling device could comprise a cooling medium pump. The cooling medium pump could be configured in such a way that the flow volume of the cooling medium is adjustable or definable by means of the cooling medium pump.

With a view toward particularly high-quality measurement results, the cooling medium pump could be low-vibration or vibration-free. This would prevent vibrations caused by the cooling medium pump from being transferred, in troublesome fashion, to a sample or to individual components of the scanning microscope or to the entire scanning microscope.

Concretely, a membrane pump, which on the one hand is low-vibration or vibration-free and on the other hand has a long service life, could be used for this purpose. Alternatively or in addition thereto, additional dampers could be provided to improve the properties.

Alternatively or in addition to conduits, embodied in the components to be cooled, for a cooling medium to flow through, the cooling device could comprise one or more modules or cooling modules attachable at points to be cooled. Such modules or cooling modules could be capable of having the cooling medium flow through and thereby able to dissipate heat from the components to be cooled, to which the modules or cooling modules are attachable in a manner producing a thermal transfer with the best possible conductivity.

The module or modules or cooling module or cooling modules could be produced from metal; copper could preferably be used here. In any case, it must be ensured that the material from which the modules or cooling modules are manufactured exhibits the highest possible thermal conductivity. To eliminate any contact voltage, all the modules or cooling modules could be manufactured from the same material. Ultimately, only identical materials could be used in the cooling circuit. In particular, a cooler and a heat exchanger could be produced from the same metal in order to prevent contact voltages via the cooling medium.

The advantage of individual modules or cooling modules is, among other things, that the modules or cooling modules can be used very flexibly. The modules or cooling modules could be arranged, for different applications, at different locations and different points to be cooled. For that purpose, the module or modules or cooling module or modules could be attachable or installable and/or removable at/from the points to be cooled with no need to interrupt a cooling circuit, constituted by the cooling medium, of the cooling device. Particularly good flexibility of the cooling device is thereby made available.

Concretely, the cooling device could comprise one or more hoses or one or more hose connections. This makes possible a flexible and individual configuration of the cooling device, matched to the particular application and the particular microscope. It makes possible, in particular, an individual and flexible arrangement of different modules or cooling modules. Silicone hoses can be used as particularly suitable hoses. To prevent the formation and/or growth of algae, the hose or hoses or hose connection or connections or reservoir vessel or vessels could be darkened or arranged in a darkened region. The aforesaid components could also be covered by means of a cover device.

Additionally in the interest of a particularly flexible configuration of the cooling device, the cooling device could comprise self-closing couplings. This prevents undesired emergence of cooling medium out of the cooling device in the context of a reconfiguration of a cooling device and an exchange of, for example, modules or cooling modules.

In the interest of reliable functioning of the cooling device and in order to prevent the accumulation of foreign bodies, foreign substances, and the like, the cooling device could comprise a filter. The filter could be arranged at a suitable point in the cooling circuit, preferably in the region of a cooling medium pump.

As a particularly economical cooling medium that can be handled without difficulty, water could be used as the cooling medium. Other cooling media are, however, conceivable.

In a particularly advantageous embodiment, the cooling medium could comprise additives, in particular in order to increase heat capacity, prevent algal growth, prevent corrosion, and/or lower the freezing point. This is to be determined by the particular application. For transport of the scanning microscope or the cooling device, in particular, an additive to lower the freezing point could be mixed into the cooling medium.

In the context of the scanning microscope according to the present invention, in particular when different, exchangeable galvanometers of the scanning device are used, a cooling element or cooling module could be moved along with it because of the flexible hoses. This makes possible particularly flexible utilization of the scanning microscope.

With the cooling device configured according to the present invention, an air-tight and therefore also largely soundproof housing of the microscope could easily be implemented. Essential components of the cooling device can be arranged outside the housing of the scanning microscope or outside a scanning head. The entry of dust and contaminants is moreover significantly reduced because of moving cooling air is eliminated.

With the scanning microscope according to the present invention it is possible, for example, to achieve a cooling performance such that 50 W in the scanning head is dissipated with a temperature difference of <10° K. at a flow rate of <1 liter/minute.

The above and other features of the invention including various novel details of construction and combinations of parts, and other advantages, will now be more particularly described with reference to the accompanying drawings and pointed out in the claims. It will be understood that the particular method and device embodying the invention are shown by way of illustration and not as a limitation of the invention. The principles and features of this invention may be employed in various and numerous embodiments without departing from the scope of the invention.

### BRIEF DESCRIPTION OF THE DRAWINGS

In the accompanying drawings, reference characters refer to the same parts throughout the different views. The drawings are not necessarily to scale; emphasis has instead been placed upon illustrating the principles of the invention. Of the drawings:

There are various ways of advantageously embodying and refining the teaching of the present invention. The reader is referred, for that purpose, on the one hand to the subordinate claims and on the other hand to the explanation below of a preferred exemplifying embodiment of the scanning microscope according to the present invention, with reference to the drawings. In conjunction with the explanation of the preferred exemplifying embodiment of the scanning microscope according to the present invention with reference to the drawings, an explanation is also given of generally preferred embodiments and refinements of the teaching. In the drawings, the single

The single FIGURE schematically depicts an exemplifying embodiment of a scanning microscope according to the present invention having a cooling device.

### DETAILED DESCRIPTION OF THE PREFERRED EMBODIMENTS

While this invention has been particularly shown and described with references to preferred embodiments thereof, it will be understood by those skilled in the art that various. changes in form and details may be made therein without departing from the scope of the invention encompassed by the appended claims.

The single FIGURE schematically depicts a scanning microscope having: a scanning device 1, a detection device 2, an electronic system 3 for operating the scanning microscope, and a cooling device 4 for at least one component of the scanning microscope. In the interest of particularly efficient cooling, cooling device 4 works with a liquid cooling medium.

Cooling device 4 shown in the present exemplifying embodiment is embodied to cool electronic system 3. Cooling device 4 could also, however, be embodied to cool scanning device 1 or detection device 2 or any other component of the scanning microscope.

Cooling device 4 comprises a cooling medium pump 5 to circulate the cooling medium, which is the present case comprises water. Cooling device 4 comprises a cooling module 6, attachable to electronic system 3, through which the cooling medium flows and which dissipates the heat generated by electronic system 3.

The cooling device comprises multiple hoses 7 that extend between cooling module 6 and a housing of cooling device 4. A heat exchanger is provided in the housing of cooling device 4.

The scanning microscope comprises a laser 8 as light source and a prism 9 for spectral spreading and detection of, for example, a light beam reflected from a specimen. The scanning microscope furthermore comprises an objective 10. For the sake of clarity, none of the beam paths of an illuminating and/or detected light beam is depicted in the single FIGURE.

Cooling modules 6 can be attached to different components of the scanning microscope. This is to be determined by the particular application.

With regard to further advantageous embodiments of the scanning microscope according to the present invention, in order to avoid repetition the reader is referred to the general portion of the description and to the appended Claims.

In conclusion, be it noted expressly that the exemplifying embodiment of the scanning microscope according to the present invention described above serves merely to describe the teaching claimed, but does not limit it to the exemplifying embodiment.

What is claimed is:

1. A scanning microscope comprising: a plurality of components, consisting essentially of a scanning device, a detection device and an electronic system for operating the scanning microscope, and a cooling device operable with a liquid cooling medium for cooling at least one component of the scanning microscope.

2. The scanning microscope according to claim 1, wherein the cooling device is embodied to cool the scanning device.

3. The scanning microscope according to claim 2, wherein the cooling device is embodied to cool at least one galvanometer of the scanning device.

4. The scanning microscope according to claim 1, wherein the cooling device is embodied to cool the detection device, preferably a photomultiplier.

5. The scanning microscope according to claim 1, wherein the cooling device is embodied to cool the electronic system, in particular an A/D converter and/or a microcontroller.

6. The scanning microscope according to claim 1, wherein the scanning device and/or the detection device and/or the electronic system and/or a housing or base of the aforesaid components and/or a housing or base of another component of the scanning microscope comprise one or more conduits for the cooling medium to flow through.

7. The scanning microscope according to claim 1, wherein the cooling device is combined with a Peltier cooling system.

8. The scanning microscope according to claim 1, wherein the cooling device comprises a preferably external cooling-medium/air heat exchanger.

9. The scanning microscope according to claim 8, wherein the cooling device comprises a heat exchanger arranged in the scanning microscope.

10. The scanning microscope according to claim 1, wherein the cooling device comprises a cooling medium pump.

11. The scanning microscope according to claim 10, wherein the cooling medium pump is low-vibration or vibration-free.

12. The scanning microscope according to claim 1, wherein the cooling device comprises one or more modules or cooling modules attachable at components to be cooled.

13. The scanning microscope according to claim 12, wherein the module or modules or cooling module or cooling modules are produced from metal, preferably from copper.

14. The scanning microscope according to any of claims 12, wherein all the modules and cooling modules are manufactured from the same material in order to eliminate any contact voltage.

15. The scanning microscope according to claim 1, wherein the cooling device (4) comprises self-closing couplings.

16. The scanning microscope according to claim 1, wherein the cooling device comprises a filter.

17. The scanning microscope according to claim 1, wherein the cooling medium comprises water.

18. The scanning microscope according to claim 1, wherein the cooling medium comprises additives, in particular in order to increase heat capacity, prevent algal growth, prevent corrosion, and/or lower the freezing point.
